(19) United States
(12) Patent Application Publication
(10) Pub. No.: US 2018/0145334 A1
(43) Pub. Date: May 24, 2018

(54) POROUS ELECTRODE FOR LITHIUM BATTERY, METHOD OF MANUFACTURING THE SAME, AND LITHIUM BATTERY INCLUDING THE SAME

(71) Applicants: SAMSUNG ELECTRONICS CO., LTD., Suwon-si (KR); THE BOARD OF TRUSTEES OF THE LELAND STANFORD JUNIOR UNIVERSITY, Stanford, CA (US)

(72) Inventors: Minsang SONG, Seongnam-si (KR); Wei LIU, Stanford, CA (US); Yi CUI, Stanford, CA (US)

(21) Appl. No.: 15/360,297

(22) Filed: Nov. 23, 2016

(51) Int. Cl. H01M 4/66; H01M 10/0525; H01M 4/139; H01M 4/04

(52) U.S. Cl. CPC H01M 4/668; H01M 10/0525; H01M 4/666; H01M 2004/021; H01M 4/0471; H01M 4/0416; H01M 4/139

(57) ABSTRACT

A porous electrode for a lithium battery, including a porous structure having a plurality of pores and including polyorganosiloxane, and an electrode active material layer disposed in the pores and on at least a portion of a surface of the porous structure.

### BACKGROUND

### 1. Field

The present disclosure relates to porous electrodes for lithium batteries, methods of manufacturing the same, and lithium batteries including the same.

### 2. Description of the Related Art

Recently, highly portable, body-attachable, wearable electronic devices have emerged onto the market, and interest in these devices continues to increase. Accordingly, a demand for shape-changeable Li-ion batteries, which may be used as power sources for such electronic devices, is gradually increasing. However, existing Li-ion batteries are of a rigid type, and thus, cannot be bent or stretched in a way suitable for use as power sources for wearable electronic devices. Such rigid characteristics are associated with the rigidity of core constitutional elements of a Li-ion battery and thus, to manufacture a shape-changeable Li-ion battery, the core constitutional elements thereof also need to be changeable in shape. The development of shape-changeable Li-ion batteries began recently. Among these Li-ion batteries, stretchable Li-ion batteries are more freely changed in shape than flexible Li-ion batteries. In a flexible Li-ion battery, some existing constitutional elements (e.g., an electrode and a separator) thereof may be applied as they are. By contrast, in a stretchable Li-ion battery, all the existing constitutional elements (e.g., electrodes, a separator, and an exterior housing) thereof need to be replaced with new stretchable materials.

Thus, there remains a need for new stretchable materials to be included in a lithium battery.

### SUMMARY

Provided are stretchable porous electrodes for lithium batteries and methods of manufacturing the same.

Provided are lithium batteries including the porous electrodes, and thus, having enhanced cell performance.

Additional aspects will be set forth in part in the description which follows and, in part, will be apparent from the description, or may be learned by practice of the presented embodiments.

According to an aspect of an embodiment, a porous electrode for a lithium battery includes:

a porous structure having a plurality of pores and including polyorganosiloxane; and

an electrode active material layer disposed in the pores and on at least a portion of a surface of the porous structure.

According to an aspect of another embodiment, a method of manufacturing the porous electrode described above includes:
a first process including:
   adding a mixture of a polyorganosiloxane prepolymer and a curing agent to a porous soluble material, and
   heat-treating the resulting mixture;
a second process including:
   preparing a porous structure having a plurality of pores and including polyorganosiloxane by mixing the heat treatment product obtained according to the first process with water to remove the porous soluble material from the heat treatment product; and
   a third process including:
   adding an electrode active material layer forming-composition including an electrode active material, a conductive agent, a binder, and a solvent to the porous structure, and
   drying the resulting composition.

According to an aspect of another embodiment, a lithium battery includes the porous electrode described above and a separator.

### BRIEF DESCRIPTION OF THE DRAWINGS

These and/or other aspects will become apparent and more readily appreciated from the following description of the embodiments, taken in conjunction with the accompanying drawings in which:

FIG. 1A is a view for explaining an electrode morphology occurring when a porous electrode according to an embodiment is stretched, and for comparison with the morphology of the porous electrode of FIG. 1A;

FIG. 1B is a view for explaining an electrode morphology when an existing metal foil-based electrode is stretched;

FIG. 2 is a view for explaining a process of manufacturing a porous electrode according to an embodiment;

FIGS. 3A to 3C are scanning electron microscope (SEM) images of sugar cubes prepared according to Preparation Example 2, sugar powder prepared according to Preparation Example 3, and a ball-milled sugar powder prepared according to Preparation Example 1, respectively;

FIGS. 3D to 3F are SEM images of polydimethylsiloxane (PDMS) sponges prepared according to Preparation Examples 2, 3, and 1, respectively;

FIGS. 3G to 3I are graphs of frequency (percent %) versus pore size (micrometers, μm) showing pore size analysis results of the PDMS sponges of Preparation Examples 2, 3, and 1, respectively;

FIGS. 4A and 4B are digital photographs showing states of a lithium tin oxide (LTO) electrode manufactured according to Example 1 and a LiFePO₄ (LFP) electrode manufactured according to Example 2, respectively, before and after stretching of the LTO electrode of Example 1 and the LFP electrode of Example 2;

FIGS. 5A and 5B are graphs of stress (megapascals, mPa) versus strain (percent, %), which are stress-strain curves of the LTO electrode of Example 1 and the LFP electrode of Example 2, respectively;

FIG. 6A is a graph of voltage (volts, V) versus capacity (milliampere hours per gram, mAhg⁻¹) showing charge and discharge characteristics of coin half-cells manufactured according to Example 1, Example 1A, Example 1B, and Comparative Example 1;

FIG. 6B is a graph of voltage (volts, V) versus capacity (milliampere hours per gram, mAhg⁻¹) showing charge and discharge characteristics of coin half-cells manufactured according to Example 2, Example 2A, Example 2B, and Comparative Example 2;

FIG. 7A is a graph of capacity (milliampere hours per gram, mAhg⁻¹) versus cycle number showing rate capabilities evaluation results of the coin half-cells of Examples 1A and 1B and Comparative Example 1;

FIG. 7B is a graph of capacity (milliampere hours per gram, mAhg⁻¹) versus cycle number showing rate capabilities evaluation results of the coin half-cells of Example 2A and Comparative Example 2;

FIGS. 8A and 8B are graphs of voltage (volts, V) versus capacity (milliampere hours per gram, mAhg⁻¹) showing stretching reliability evaluation results of the LTO electrode of Example 1 and the LFP electrode of Example 2, respectively;

FIG. 9A is a graph of voltage (volts, V) versus capacity (milliampere hours per gram, mAhg⁻¹) showing 0.2 C charge-discharge characteristics of a full cell manufactured according to Example 3;

FIG. 9B is a graph of capacity (milliampere hours per gram, mAhg⁻¹) and coulombic efficiency (percent, %) versus cycle number showing 1.0 C charge-discharge characteristics of a full cell manufactured according to Example 3;

FIG. 10A is a schematic view illustrating a structure in which a porous separator according to an embodiment includes inorganic particles and a binder;

FIG. 10B is a schematic view illustrating a structure in which the porous separator of FIG. 10A does not include inorganic particles and a binder; and

FIG. 11 is an image of PDMS separators prepared according to Example 4 having various thicknesses.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present disclosure. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

The term “mixture” as used herein refers to any combination and is not limited to any physical form.

Hereinafter, a porous electrode for a lithium battery, according to an embodiment, a method of manufacturing the porous electrode, and a lithium battery including the same will be described in more detail.

According to an embodiment, a porous electrode for a lithium battery includes:

a porous structure having a plurality of pores and including polyorganosiloxane;

and an electrode active material layer disposed in the pores and on at least a portion of a surface of the porous structure.

The electrode active material layer may be present in the pores of the porous structure and also be on the surface of the porous structure.

The porous electrode may be, for example, a porous sponge electrode.

The pores have a three-dimensionally interconnected structure. The three-dimensionally interconnected structure may be confirmed using a scanning electron microscope (SEM) and by injection of a solution or the like and evaluating whether or not the solution permeates thereinto.

The porous electrode may have an average pore size of about 0.1 micrometers (μm) to about 50 μm, for example, about 1 μm to about 50 μm, for example, about 10 μm to about 47 μm, and, for example, about 5 μm to about 47 μm. When the average pore size of the porous electrode is within the above ranges, in the process of fabrication of the porous electrode, an electrode active material composition may be easily injected and a liquid electrolyte may smoothly flow.

The term “pore size” as used herein refers to an average diameter of pores when the pores are spherical. When pores are non-spherical, the term “pore size” as used herein refers to a major axis length of the pores.

The polyorganosiloxane may have an elastic modulus of about 10 megapascals (MPa) or less, for example, about 0.5 MPa to about 5 MPa, or for example, about 1 MPa to about 3 MPa. The polyorganosiloxane has the elastic modulus range described above and very high elongation. The polyorganosiloxane has an elongation of about 100% or more, for example, about 100% to about 300%. The porous electrode including the polyorganosiloxane is stable in an electrolyte or at an electrode operating voltage.

The porous electrode may have a porosity of about 65% to about 80%, for example, about 70% to about 75%. The term “porosity” as used herein means the porosity of the porous electrode in a state in which the porous electrode does not include the electrode active material layer.

The polyorganosiloxane may be, for example, at least one selected from:

at least one polymer selected from polydimethylsiloxane (PDMS), vinyl-terminated PDMS, hydroxyl-terminated PDMS, and polyhydrosiloxane;

a copolymer having repeating units of the aforementioned at least one polymer; and

a polymerization product thereof.

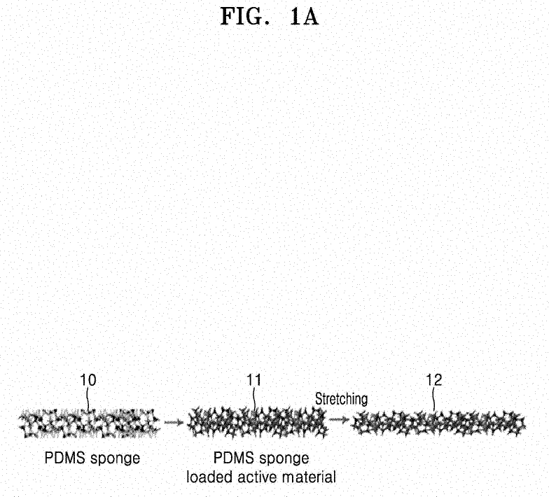

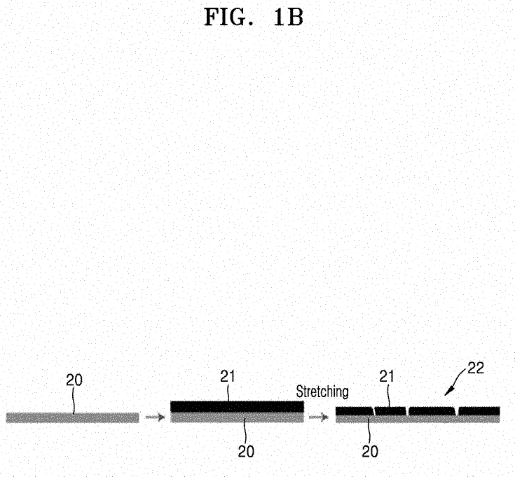

An electrode for a general rigid-type Li-ion battery uses an aluminum or copper foil as a substrate, and thus, it is very difficult to stretch such an electrode due to the rigid mechanical characteristics of the metals. As illustrated in FIG. 1B, when an electrode 22, including a current collector 20, e.g., an aluminum or copper foil, and an active material layer 21 disposed on the current collector 20, is stretched, defects occur in the active material layer 21, thus changing the morphology of the electrode 22. A separator also uses a polyethylene (PE) or polypropylene (PP)-based material having a high elastic modulus, thus making it difficult to stretch the separator. Therefore, to manufacture a stretchable electrode and separator, the metal and PE/PP need to be replaced with a PDMS material, which has a high elongation and is electrochemically stable. In addition to the metal foil as a substrate, it is also impossible to stretch an inorganic electrode active material and a carbonaceous conductive material, which constitutes an electrode, and thus, these materials need to be replaced with new stretchable materials. Up to date, however, suitable stretchable materials which may replace these materials have not yet been discovered.

Therefore, the inventors of the present application provide a stretchable porous electrode for a lithium battery, including:

a porous structure having a plurality of pores and including polyorganosiloxane; and

an electrode active material layer disposed in the pores and on at least a portion of a surface of the porous structure.

The porous electrode has a porous structure having pores through which a liquid electrolyte permeates.

The porous electrode may be, for example, a PDMS sponge and, as illustrated in FIG. 1A, an active material is supplied to a PDMS sponge 10 to obtain an active material-loaded PDMS sponge 11. The active material-loaded PDMS sponge 11 is stretched to obtain a stretchable porous PDMS sponge electrode 12. The active material-loaded PDMS sponge 11 maintains its morphology even after the stretching process, as illustrated in FIG. 1A.

The porous electrode may have an elongation of about 1% to about 90%, for example, about 60% to about 85%, or for example, about 70% to about 75%. The high elongation enables the porous electrode to be processed in a desired form, and thus, a lithium battery with enhanced charge, discharge, and lifespan characteristics, before and after stretching, may be manufactured.

Hereinafter, a method of manufacturing the porous electrode, according to an embodiment will be described.

First, a mixture of a polyorganosiloxane prepolymer and a curing agent is added to a porous soluble material, and the resulting mixture is then heat-treated. The combination of the above steps is referred to as a first process.

In the first process, the porous soluble material may be milled to obtain a porous material having an average pore size of about 1 μm to about 50 μm.

As described above, when the mixture of a polyorganosiloxane prepolymer and a curing agent is provided and heat-treated, the mixture of a polyorganosiloxane prepolymer and a curing agent is cured to produce polyorganosiloxane. The heat treatment temperature varies depending on types of the polyorganosiloxane prepolymer and the curing agent, and may range from, for example, about 50° C. to about 90° C.

The polyorganosiloxane prepolymer may be at least one selected from PDMS, vinyl-terminated PDMS, hydroxyl-terminated PDMS, and polyhydrosiloxane.

The vinyl-terminated PDMS may be, for example, an oligomer represented by Formula 1 below:

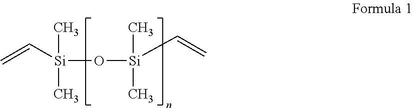

wherein, in Formula 1, n is an integer of 10 to 100.

The curing agent may be, for example, a compound represented by Formula 2 below or a compound having a silicon-hydride bond.

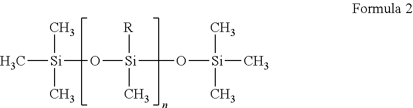

wherein, in Formula 2,

n is an integer of 1 to 100, and

R is hydrogen, a C₁-C₁₀ alkyl group, a C₃-C₁₀ cycloalkyl group, a C₁-C₁₀ fluoroalkyl group, or a C₃-C₁₀ fluorocycloalkyl group.

In an embodiment, R may be, for example, a methyl group, an ethyl group, a propyl group, a butyl group, a pentyl group, or a hexyl group.

The polyhydrosiloxane.may be a compound represented by Formula 1a.

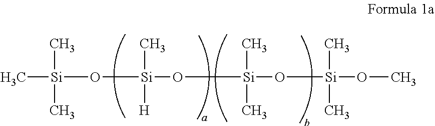

wherein, in Formula 1 a,

a is an integer of 1 to 50, and

b is a is an integer of 1 to 50.

The amount of the curing agent may be from about 2 parts by weight to about 20 parts by weight, for example, from about 5 parts by weight to about 10 parts by weight based on 100 parts by weight of the polyorganosiloxane prepolymer. While not wishing to be bound by theory, it is understood that when the amount of the curing agent is within the above range, polyorganosiloxane with a high elongation may be prepared.

According to an embodiment, the curing of the polyorganosiloxane prepolymer and the curing agent may be performed according to Reaction Scheme 1 below:

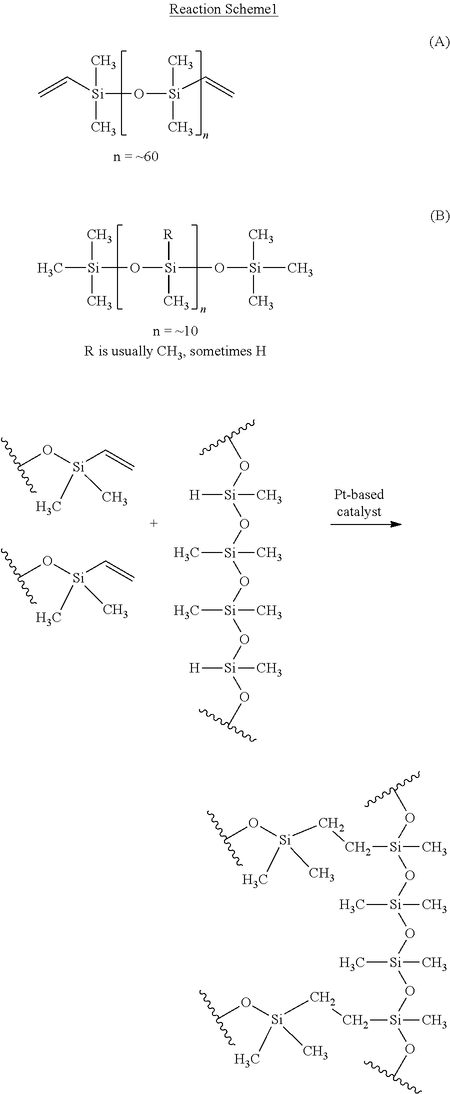

Referring to Reaction Scheme 1, a silicon elastomer (A), which is a polyorganosiloxane prepolymer, has a vinyl group. A cross-linkable oligomer (B) as a curing agent has at least three silicon-hydrogen bonds.

The curing agent includes a platinum-based catalyst, and this catalyst accelerates an addition reaction of a Si—H bond across the double bond of a vinyl group. This three-dimensional cross-linking proceeds by a multiple reaction of the silicon elastomer and the cross-linkable oligomer.

When the ratio of the amount of the cross-linkable oligomer to the amount of the silicon elastomer increases, much more cross-linkable elastomer may be formed. In addition, cross-linking may be further accelerated by a heat treatment.

The porous soluble material, which has pores and is soluble in water, is used as a template for forming pores of the porous electrode. The porous soluble material may be, for example, a sugar lump, a sugar powder, a sugar cube, or a ball-milled sugar powder.

The sugar cube may be commercially available under the product name of Domino Granulated Pure Cane Sugar (15×15×15 millimeters) (manufactured by Domino Foods, Inc., West Palm Beach, Fla., USA) or may be homemade.

Homemade sugar cubes may be prepared by dry pressing a ball-milled sugar powder.

The polyorganosiloxane prepolymer and the curing agent are commercially available under the product name of Sylgard 184 (manufactured by Dow Corning corporation, Midland, Mich., USA).

Subsequently, to prepare a porous structure having a plurality of pores and including polyorganosiloxane, the heat treatment product obtained according to the first process is mixed with water to remove the porous soluble material therefrom, which is referred to as a second process.

The method of manufacturing the porous electrode may further include performing plasma treatment, UV irradiation, or ozone treatment on the porous structure obtained according to the second process. By the plasma treatment, UV irradiation, or ozone treatment, the porous structure becomes hydrophilic and, accordingly, various compositions added to the porous structure, for example, an electrode slurry and an electrolyte, have enhanced wettability.

To manufacture a porous electrode, a composition for forming an electrode active material layer, including an electrode active material, a conductive agent, a binder, and a solvent, is added to the porous structure and the resulting solution is dried. This sequence of steps is referred to as a third process.

The porous electrode is stretched to fabricate a stretchable porous electrode. The elongation of the porous electrode is adjusted to be from about 1% to about 90%, for example, from about 60% to about 85%, or for example, from about 75% to about 80%.

The porous electrode may be manufactured simply and easily using sugar as a template as described above.

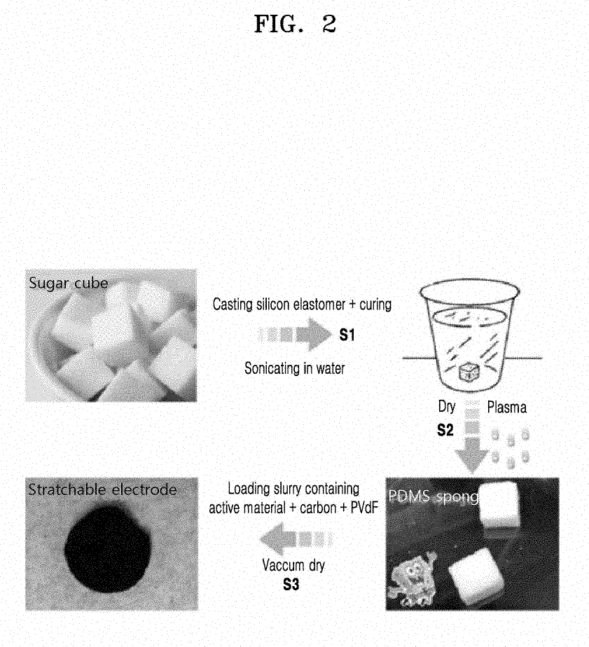

FIG. 2 illustrates a process of manufacturing a porous electrode according to an embodiment, that is, a stretchable PDMS sponge electrode.

Referring to FIG. 2, a mixture of a silicon elastomer and a curing agent is added to sugar cubes, which are composed of a porous soluble material, and the resulting mixture is heat-treated to form polyorganosiloxane.

The method of adding the mixture to the sugar cubes is not particularly limited and may be, for example, casting as illustrated in FIG. 2.

The resulting material is dissolved in water and subjected to sonication to remove the porous soluble material (operation S1).

Subsequently, the resulting product is subjected to plasma treatment to obtain a porous PDMS sponge (operation S2).

An active material composition including an active material, a conductive agent, a binder, and a solvent, is added to the plasma-treated porous PDMS sponge, and the resulting material is dried in a vacuum to manufacture a porous PDMS sponge electrode with an active material layer disposed in pores and on at least a surface thereof (operation S3).

The drying process is performed to remove a solvent or the like and may be performed at a temperature ranging from about 30° C. to about 100° C., for example, from about 30° C. to about 80° C., or for example, from about 50° C. to about 60° C.

The electrode active material may be a cathode active material or an anode active material. As the cathode active material, an electrochemical active material composite according to an embodiment may be used. In addition, the electrode active material may further include an additional cathode active material, which is a cathode active material generally used in lithium batteries.

The additional cathode active material may include at least one selected from lithium cobalt oxide, lithium nickel cobalt manganese oxide, lithium nickel cobalt aluminum oxide, lithium iron phosphate, and lithium manganese oxide, but is not limited thereto. Any cathode active material available in the art may be used.

For example, the cathode active material may be a compound represented by one of the following formulae: LiₐA_{1-b}B′_{b}D′₂ (wherein 0.90≤a≤1.8 and 0≤b≤0.5); LiₐE_{1-b}B′_{b}O_{2-c}D′_{c} (wherein 0.90≤a≤1.8, 0≤b≤0.5, and 0≤c≤0.05); LiE_{2-b}B′_{b}O_{4-c}D′_{c} (wherein 0≤b≤0.5 and 0≤c≤0.05); LiₐNi_{1-b-c}Co_{b}B′_{c}D′_{α} (wherein 0.90≤a≤1.8, 0≤b≤0.5, 0≤c≤0.05, and 0<α≤2); LiₐNi_{1-b-c}Co_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}D′_{α} (wherein 0.90≤a≤1.8, 0≤b≤0.5, 0≤c≤0.05, and 0<α<2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₅; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae above, A is selected from nickel (Ni), cobalt (Co), manganese (Mn), and combinations thereof; B′ is selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D′ is selected from oxygen (O), fluorine (F), sulfur (S), phosphorus (P), and combinations thereof; E is selected from cobalt (Co), manganese (Mn), and combinations thereof; F′ is selected from fluorine (F), sulfur (S), phosphorus (P), and combinations thereof; G is selected from aluminum (Al), chromium (Cr), manganese (Mn), iron (Fe), magnesium (Mg), lanthanum (La), cerium (Ce), strontium (Sr), vanadium (V), and combinations thereof; Q is selected from titanium (Ti), molybdenum (Mo), manganese (Mn), and combinations thereof; I′ is selected from chromium (Cr), vanadium (V), iron (Fe), scandium (Sc), yttrium (Y), and combinations thereof; and J is selected from vanadium (V), chromium (Cr), manganese (Mn), cobalt (Co), nickel (Ni), copper (Cu), and combinations thereof.

Examples of the conductive agent may include carbon black, graphite particles, natural graphite, artificial graphite, acetylene black, Ketjen black or carbon fibers; carbon nanotubes, or metal powders, metal fibers or metal tubes of copper, nickel, aluminum, silver, or the like; and conductive polymers such as polyphenylene derivatives. However, the conductive agent is not limited to the above examples, and any conductive agent used in the art may be used here.

Examples of the binder may include vinylidene fluoride/hexafluoropropylene copolymers, polyvinylidene fluoride, polyimide, polyethylene, polyester, polyacrylonitrile, polymethylmethacrylate, polytetrafluoroethylene (PTFE), carboxymethyl cellulose/styrene-butadiene rubber (CMC/SBR) copolymers, SBR-based polymers, and mixtures thereof.

Examples of the solvent may include N-methylpyrrolidone, acetone and water. However, the solvent is not limited to the above examples, and the examples of the solvent may include any material that can be used as a solvent in the related art.

The amounts of the electrode active material, the conductive agent, the binder, and the solvent are the amounts commonly used in lithium batteries in the pertinent art. At least one of the conductive agent, the binder, and the solvent may be omitted, if desired, depending on use and configuration of a lithium battery.

The anode active material may be a carbonaceous material, silicon, a silicon oxide, a silicon-based alloy, a silicon-carbonaceous material composite, tin, a tin-based alloy, a tin-carbon composite, a metal oxide, or a combination thereof.

The carbonaceous material may be crystalline carbon, amorphous carbon, or a mixture thereof. The crystalline carbon may be graphite, such as natural graphite or artificial graphite that is in amorphous, a plate, a flake, or a particle in a spherical or fibrous form. The amorphous carbon may be soft carbon (carbon sintered at low temperatures), hard carbon, mesophase pitch carbides, sintered corks, graphene, carbon black, fullerene soot, carbon nanotubes, and carbon fibers. However, embodiments are not limited to the above examples and any anode active material used in the art may be used.

The anode active material may be selected from Si, SiOₓ where 0<x<2, for example, 0.5<x<1.5, Sn, SnO₂, a silicon-containing metal alloy, and mixtures thereof. A metal that is alloyable with silicon may be at least one selected from Al, Sn, Ag, Fe, Bi, Mg, Zn, In, Ge, Pb, and Ti.

The anode active material may include a metal/metalloid alloyable with lithium, an alloy thereof, or an oxide thereof. Examples of the metal/metalloid alloyable with lithium include Si, Sn, Al, Ge, Pb, Bi, Sb, a Si—Y alloy (wherein Y is an alkali metal, an alkali earth metal, a Groups 13 and 14 element, a transition metal, a rare earth element, or a combination thereof except for Si), a Sn—Y alloy (wherein Y is an alkali metal, an alkali earth metal, a Groups 13 and 14 element, a transition metal, a rare earth element, or a combination thereof except for Sn), and MnOₓ where 0<x≤2. Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), polonium (Po), or combinations thereof. Non-limiting examples of the oxide of the metal/metalloid alloyable with lithium include a lithium titanium oxide, a vanadium oxide, a lithium vanadium oxide, SnO₂, and SiOₓ (where 0<x<2).

For example, the anode active material may include at least one element selected from Groups 13 to 15 of the Periodic Table.

For example, the anode active material may include at least one element selected from Si, Ge, and Sn.

The anode active material may be, for example, a compound represented by Formula 3 below:

Li₄₊ₐTi_{5-b}M_{c}O_{12-d} Formula 3

wherein, in Formula 3, −0.2≤a≤0.2, −0.3≤b≤0.3, 0≤c≤0.3, and −0.3≤d≤0.3, and M is at least one metal selected from Groups 1 to 6 and 8 to 15 of the Periodic Table.

In Formula 3, M may be selected from lithium (Li), sodium (Na), magnesium (Mg), aluminum (Al), calcium (Ca), strontium (Sr), chromium (Cr), vanadium (V), iron (Fe), cobalt (Co), nickel (Ni), zirconium (Zr), zinc (Zn), silicon (Si), yttrium (Y), niobium (Nb), gallium (Ga), tin (Sn), molybdenum (Mo), tungsten (W), barium (Ba), lanthanum (La), cerium (Ce), silver (Ag), tantalum (Ta), hafnium (Hf), ruthenium (Ru), bismuth (Bi), antimony (Sb), and arsenic (As).

The compound of Formula 3 has a spinel-type structure and may be, for example, Li₄Ti₅O₁₂ (LTO).

The cathode active material may be a compound represented by Formula 4 below:

LiMₓFe₁₋ₓPO₄ Formula 4

wherein, in Formula 4,

M is at least one metal selected from Co, Ni, and Mn, and

0≤x≤1.

The compound of Formula 4 may be, for example, LiFePO₄ (LFP).

The porous electrode for a lithium battery is manufactured according to the manufacturing processes described above.

According to an embodiment, a stretchable electrode and a separator, manufactured using a three-dimensional (3D) porous PDMS polymer as a framework, may be utilized as core constitutional elements to manufacture a stretchable Li-ion battery.

The porous electrode may be used as stretchable electronic materials and as an electrode and separator of a stretchable Li-ion battery for shape-changeable and body-attachable electronic devices, e.g., wearable electronic devices.

According to another embodiment, a lithium battery includes the porous electrode described above and a separator.

The separator may be, for example, a porous structure having a plurality of pores and including polyorganosiloxane.

The porous structure may have an average pore size of about 1 μm to about 50 μm, for example, about 5 μm to about 30 μm and a thickness of about 10 μm to about 100 μm, for example, about 25 μm to about 75 μm. While not wishing to be bound by theory, it is understood that when the average pore size and thickness of the porous structure are within the ranges described above, a lithium battery with high cell performance may be manufactured.

The thickness of the porous structure may be from about 10 μm to about 100 μm, for example, from about 10 μm to about 60 μm, or for example, from about 25 μm to about 50 μm.

According to an embodiment, the separator may have a porous structure having a plurality of pores and including polyorganosiloxane, in which inorganic particles are disposed in the pores of the porous structure. The porous separator may be, for example, a 3D porous PDMS separator.

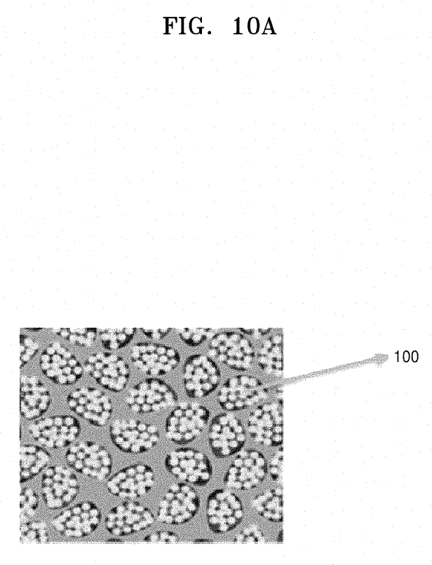

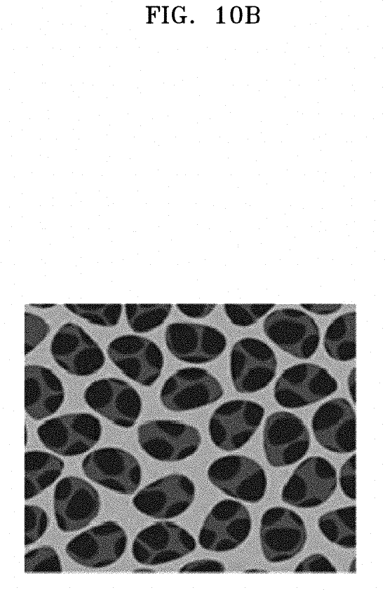

As illustrated in FIG. 10A, the 3D porous separator has a structure in which a 3D porous sponge includes inorganic particles and a binder 100. FIG. 10B illustrates a 3D porous sponge that does not include inorganic particles and a binder.

The inorganic particles include at least one selected from silica (SiO₂), alumina (Al₂O₃), zirconium oxide (ZrO₂), titanium oxide (TiO₂), and mixtures thereof. The binder may be polyvinylidene fluoride, a vinylidene fluoride/hexafluoropropylene copolymer, polyimide, polyethylene, polyester, polyacrylonitrile, polymethylmethacrylate, PTFE, an SMC/SBR copolymer, an SBR-based polymer, or a mixture thereof.

The inorganic particles have a diameter of about 0.1 μm to about 50 μm, for example, about 5 μm to about 20 μm.

The 3D porous separator may be obtained by coating a 3D porous sponge with a composition including inorganic particles, a binder, and a solvent, and drying the resulting structure. In this regard, the solvent may be N-methylpyrrolidone, acetone, or water.

The amount of the inorganic particles is not particularly limited and may be, for example, from about 0.1 parts by weight to about 30 parts by weight, for example, from about 1 parts by weight to about 25 parts by weight, or for example, from about 5 parts by weight to about 20 parts by weight based on 100 parts by weight of the 3D porous sponge. The amount of the binder is not particularly limited and may be, for example, from about 0.1 parts by weight to about 30 parts by weight, for example, from about 1 parts by weight to about 25 parts by weight, or for example, from about 5 parts by weight to about 20 parts by weight based on 100 parts by weight of the 3D porous sponge. While not wishing to be bound by theory, it is understood that when the amounts of the inorganic particles and the binder are within the above ranges, a lithium battery having excellent capacity and lifespan characteristics without the possibility/occurrence of an interelectrode short circuit may be manufactured.

An all PDMS-based stretchable battery having a structure in which electrodes and a separator are attached to each other may be manufactured using a PDMS LTO anode, a PDMS LFP anode, and a PDMS separator. The PDMS separator may be surface-treated with ozone or UV, whereby the PDMS surface is easily attached to other materials. Such a lithium battery is stretched at the same strain, and thus, the occurrence of an internal short circuit may be prevented.

Hereinafter, a method of manufacturing a lithium battery, according to an embodiment will be described.

The porous electrode, a lithium salt-containing non-aqueous electrolyte, and a separator are assembled to manufacture a lithium battery.

The lithium salt-containing non-aqueous electrolyte includes a non-aqueous electrolyte and a lithium salt. The non-aqueous electrolyte may be a non-aqueous electrolytic solution, an organic solid electrolyte, or an inorganic solid electrolyte.

The non-aqueous electrolytic solution includes an organic solvent. The organic solvent may be any suitable organic solvent used in the art. The organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, N, N-dimethylacetamide, dimethylsulfoxide, dioxane, 1,2-dimethoxyethane, sulfolane, dichloroethane, chlorobenzene, nitrobenzene, diethylene glycol, dimethyl ether, a mixture thereof, or the like.

Non-limiting examples of the organic solid electrolyte include polyethylene derivatives, polyethylene oxide derivatives, polypropylene oxide derivatives, phosphoric acid ester polymers, polyester sulfide, polyvinyl alcohols, and polyvinylidene fluoride, and polymers having ionic dissociation groups.

Non-limiting examples of the inorganic solid electrolyte include Li₃N, LiI, Li₅NI₂, Li₃N—LiI—LiOH, Li₂SiS₃, Li₄SiO₄, Li₄SiO₄—LiI—LiOH, and Li₃PO₄—Li₂S—SiS₂.

The lithium salt is a material that is readily soluble in the non-aqueous electrolyte. Examples thereof include LiPF₆, LiBF₄, LiSbF₆, LiAsF₆, LiClO₄, LiCF₃SO₃, Li(FSO₂)₂N, Li(CF₃SO₂)₂N, LiC₄F₉SO₃, LiAlO₂, LiAlCl₄, and LiN(CₓF₂ₓ₊₁SO₂)(C_{y}F_{2y+1}SO₂), where x and y are natural numbers, LiCI, LiI, a mixture thereof, or the like. In addition, in order to enhance charge/discharge characteristics and flame retardancy, for example, pyridine, triethylphosphite, triethanolamine, cyclic ether, ethylenediamine, n-glyme, hexamethyl phosphoramide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride, or the like, may be added to the non-aqueous electrolyte. In some embodiments, in order to impart incombustibility, the electrolyte may further include a halogen-containing solvent such as carbon tetrachloride, ethylene trifluoride, or the like.

A separator may be disposed between a cathode and an anode and, as the separator, an insulating thin film having high ion permeability and mechanical strength is used.

The separator generally has a pore diameter of about 0.01 μm to about 10 μm, for example, about 0.1 μm to about 5 μm, and a thickness of about 5 μm to about 20 μm, for example, about 10 μm to about 15 μm. The separator may be sheets or non-woven fabrics made of an olefin-based polymer such as polypropylene or the like, or glass fibers or polyethylene. When a solid polymer electrolyte is used, the solid polymer electrolyte may also serve as a separator.

The separator made of an olefin-based polymer may be, for example, a single layer of polyethylene, polypropylene, or polyvinylidene fluoride, or multiple layers of at least two of these materials, or a mixed multi-layer, such as a polyethylene/polypropylene layer, a polyethylene/polypropylene/polyethylene layer, or a polypropylene/polyethylene/polypropylene layer.

According to another embodiment, a stretchable porous separator may be used as the separator. As such, when the stretchable porous electrode and the stretchable porous separator are used, an easily processable lithium battery having a high elongation may be manufactured.

According to another embodiment, an all-PDMS-based stretchable Li-ion battery includes a stretchable PDMS cathode, anode, and separator. In this regard, the all-PDMS-based stretchable Li-ion battery is of a one-body type in which a stretchable PDMS separator and an interface between stretchable PDMS electrodes are attached to each other.

In the lithium battery, PDMS components included in the electrodes and the separator may be confirmed by Fourier-transform infrared spectroscopy (FT-IR), Raman spectroscopy, or the like.

The lithium battery may have a capacity retention of about 80% or more, for example, about 80% to about 99% after stretching 500 times.

One or more embodiments will now be described in further detail with reference to the following examples. These examples are for illustrative purposes only and are not intended to limit the scope of the one or more embodiments.

### EXAMPLES

### Preparation Example 1

### Preparation of Porous PDMS Sponge (Using a Ball-Milled Sugar Powder)

A 3D interconnected porous PDMS sponge was prepared according to the following processes by using homemade sugar cubes as a template.

First, a plastic beaker was filled with a sugar powder and subjected to high-pressure dry pressing. Thereafter, zirconia balls were added thereinto and milling was performed using a planetary ball miller (QM-QX04 available from Instrument factory of Nanjing University, China) at about 400 revolutions per minute (rpm) for 30 minutes to decrease a grain size of the sugar powder.

The ball-milled sugar powder was prepared back into sugar cubes through dry pressing, and then, a mixture of a silicon elastomer and a curing agent in a weight ratio of 10:1 (Sylgard 184 available from Dow Corning Corporation, Midland, Mich., USA) was cast on the sugar cubes.

The Young's modulus of PDMS may be adjusted using a ratio of the silicon elastomer to the curing agent. Curing was performed at 50° C. for 24 hours, and then, PDMS located on the surface of the sugar powder was removed until the surface of the sugar powder was exposed. Thereafter, the sugar powder was dissolved in water and subjected to sonication for 5 hours to remove the porous soluble material. Subsequently, the resultant material was dried in a vacuum at 60° C. for 10 hours to obtain a PDMS sponge.

The PDMS sponge was cut using a cryostat microtome (Microm 550M) to form a disk-type PDMS sponge having an area of about 1 square centimeters (cm²) and a thickness of about 500 μm. The disk-type PDMS sponge was subjected to argon plasma treatment in an RF plasma chamber (Model MPS-300 available from March Instruments, Inc., Concord, Calif., USA) for 3 minutes.

### Preparation Example 2

A porous PDMS sponge was prepared in the same manner as in Preparation Example 1, except that commercially available sugar cubes under the product name of Domino Granulated Pure Cane Sugar (15×15×15 mm) (Domino Foods, Inc., West Palm Beach, Fla., USA) were used instead of the ball-milled sugar powder.

### Preparation Example 3

A commercially available sugar powder was used instead of the ball-milled sugar powder.

### Preparation Example 4

A composition obtained by mixing Al₂O₃ and polyvinylidene fluoride (PVdF) in a mixing weight ratio of 10:1 with N-methyl-2-pyrrolidone (NMP) was cast on the 3D PDMS sponge prepared according to Preparation Example 1, and the resulting structure was dried at 60° C.

As such, a 3D porous PDMS separator, in which the 3D PDMS sponge was filled with Al₂O₃ and polyvinylidene fluoride, was manufactured.

### Example 1

### Manufacture of Coin Half-Cell

An anode slurry was prepared by mixing Li₄Ti₅O₁₂ (LTO), carbon black (MTI Corporation), and PVdF (MTI Corporation) in a weight ratio of 80:10:10 with NMP (Sigma-Aldrich).

The anode slurry obtained according to the process described above was applied to the porous PDMS sponge of Preparation Example 1, and the resulting structure was dried at about 70° C. to manufacture an LTO electrode. In this regard, a loading amount of LTO was about 1.7 milligrams per square centimeter (mg/cm²).

The LTO electrode, an Li metal foil, a Celgard separator, and a liquid electrolyte (1.0 molar (M) LiPF₆ in EC:DEC (1:1, weight to weight, w/w) were used to manufacture a CR2032 coin half-cell (LTO/Li). The cell assembling process was performed in an Ar-filled dry glove box.

### Example 1A

A coin half-cell was manufactured in the same manner as in Example 1, except that the loading amount of LTO was about 6.0 mg/cm² instead of 1.7 mg/cm².

### Example 1B

A coin half-cell was manufactured in the same manner as in Example 1, except that the loading amount of LTO was about 14 mg/cm² instead of 1.7 mg/cm².

### Example 2

### Manufacture of Coin Half-Cell

A cathode slurry was prepared by mixing LiFePO₄ (LFP) powder, carbon black (MTI Corporation), and PVdF (MTI Corporation) in a weight ratio of 80:10:10 with NMP (Sigma-Aldrich).

The cathode slurry was cast on the porous PDMS sponge of Preparation Example 1, and the resulting structure was dried at about 70° C. to manufacture a stretchable LFP electrode. In this regard, a loading amount of LFP in the LFP electrode was 1.5 mg/cm².

The LFP electrode, an Li metal foil, a Celgard separator, and a liquid electrolyte (1.0 M LiPF₆ in EC:DEC (1:1, w/w)) were used to manufacture a CR2032 coin half-cell (LFP/Li). The cell assembling process was performed in an Ar-filled dry glove box.

### Example 2A

### Manufacture of Coin Half-Cell

A coin half-cell was manufactured in the same manner as in Example 2, except that the loading amount of LFP was 7.0 mg/cm² instead of 1.5 mg/cm².

### Example 2B

### Manufacture of Coin Half-Cell

A coin half-cell was manufactured in the same manner as in Example 2, except that the loading amount of LFP was 10 mg/cm² instead of 1.5 mg/cm².

### Example 3

### Manufacture of Full Cell

The LTO electrode manufactured according to Example 1, the LFP electrode manufactured according to Example 2, a Celgard separator, and a liquid electrolyte (1.0 M LiPF₆ in EC:DEC (1:1, w/w)) were used to manufacture an all-PDMS-based full cell (LTO/LFP). The full cell assembling process was performed in an Ar-filled dry glove box.

### Example 4

### Manufacture of Full Cell

A full cell was manufactured in the same manner as in Example 3, except that the 3D PDMS sponge prepared according to Preparation Example 4 was used instead of the Celgard separator.

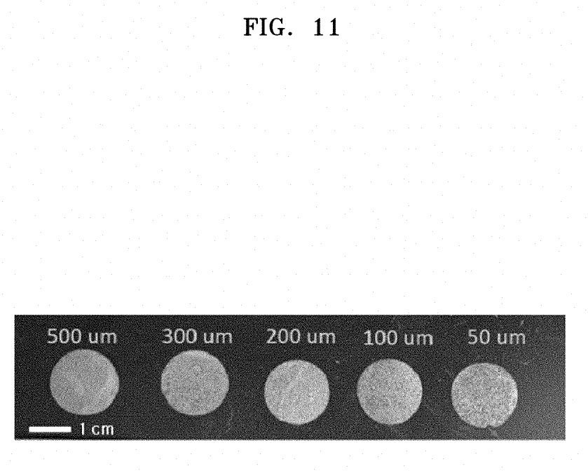

The 3D PDMS sponge of Preparation Example 4 was cut using a cryostat microtome (Microm 550M) to form disk-type 3D PDMS sponges having thicknesses of 500 μm, 300 μm, 200 μm, 100 μm, and 50 μm (FIG. 11).

A pristine PDMS sponge having a thickness of 300 μm and an alumina (Al₂O₃)-filled porous PDMS sponge having a thickness of 50 μm were each used as a separator to manufacture a pouch-type full cell and an all-PDMS-based full cell, respectively.

The Al₂O₃-filled porous PDMS sponge was prepared by applying, to the 3D PDMS sponge of Preparation Example 4, a composition including Al₂O₃, vinylidene fluoride, and acetone as a solvent, and drying the resulting structure at about 60° C.

### Comparative Example 1

### Coin Half-Cell

A coin half-cell was manufactured in the same manner as in Example 1, except that, in the fabrication of an anode, the anode slurry was cast on a Cu foil as an anode current collector by using a doctor blade and the resulting structure was dried in a vacuum at about 70° C. overnight.

### Comparative Example 2

### Coin Half-Cell

A coin half-cell was manufactured in the same manner as in Example 2, except that, in the fabrication of a cathode, the cathode slurry was cast on an Al foil as a cathode current collector, and the resulting structure was dried in a vacuum at 70° C. overnight.

### Evaluation Example 1

### Controlling Average Pore Size of Sugar by Ball Milling and Analysis of Pore Structure of 3D Porous Sponge

The ball-milled sugar powder of Preparation Example 1, the sugar cubes of Preparation Example 2, and the sugar powder of Preparation Example 3 were analyzed using a scanning electron microscope (SEM). The SEM analysis was performed using FEI XL30 Sirion SEM with a field emission gun (FEG) source operated at an accelerating voltage of 5 kilovolts (kV) and with an EDS detector, and a morphology of each sample was evaluated.

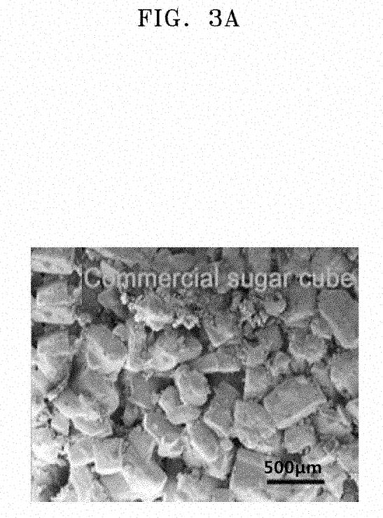

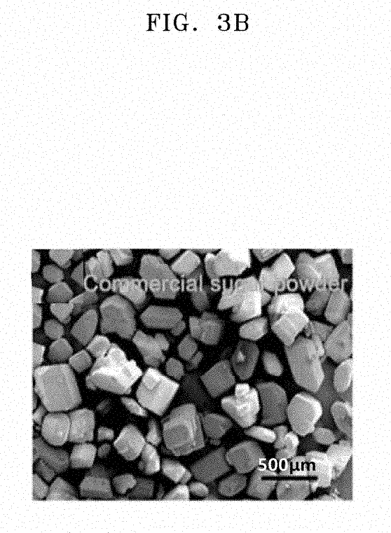

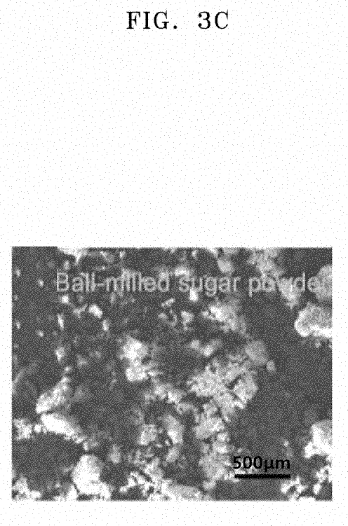

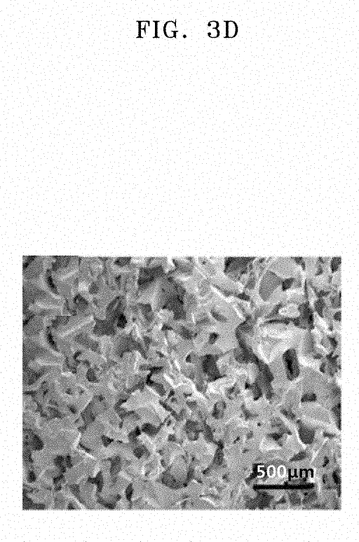

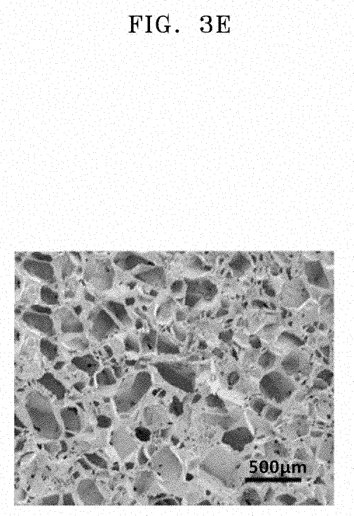

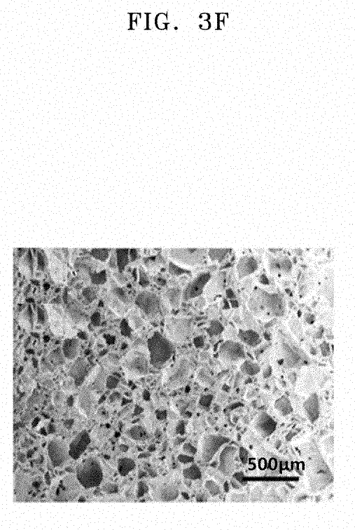

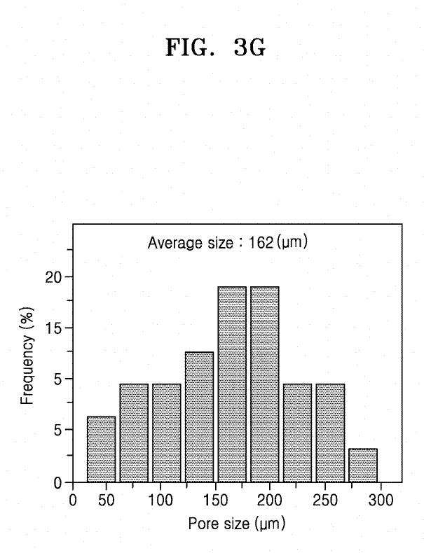

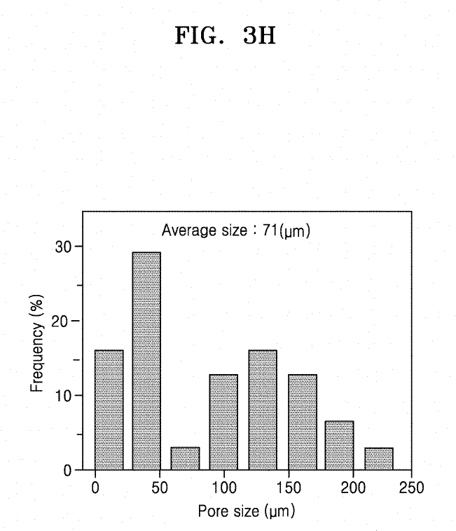

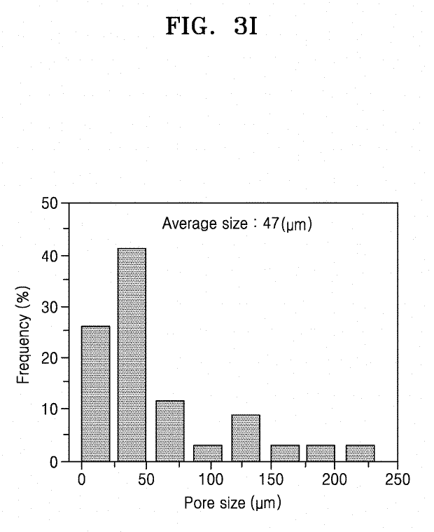

The SEM analysis results of the respective samples are shown in FIGS. 3C, 3A, and 3B. In addition, SEM images of the PDMS sponges of Preparation Examples 1 to 3 are shown in FIGS. 3F, 3D, and 3E, respectively. Pore size analysis results of the PDMS sponges of Preparation Examples 2, 3 and 1 are shown in FIGS. 3G to 3I, respectively. In FIGS. 3G to 3I, a scale bar represents about 500 μm.

Referring to the drawings, it is confirmed that the PDMS sponge of Preparation Example 1 had an average pore size of about 47 μm. The PDMS sponges of Preparation Examples 2 and 3 had average pore sizes of about 102 μm and about 71 μm, respectively. From the above results, it is confirmed that when an average particle size was decreased by ball milling, the average pore size of the PDMS sponge decreased, as compared to a case in which sugar cubes or unmilled sugar powder was used.

### Evaluation Example 2

### Charge and Discharge Characteristics

### 1) Examples 1, 1A and 1B and Comparative Example 1

Charge and discharge characteristics of the coin half-cells manufactured according to Examples 1, 1A and 1B and Comparative Example 1 were evaluated.

The charge and discharge characteristics of each coin half-cell were evaluated under the following conditions.

Each coin half-cell was charged at a constant current (CC) of 0.1 C up to 1.0 volts (V), and then, discharged at a CC of 0.1 C until the voltage reached 2.5 V, and this cycle of charging and discharging was repeated 50 times.

A galvanostatic charge/discharge test of each coin half-cell was conducted using a 96-channel battery tester (Arbin Instruments) and the C-rate used was calculated based on a theoretical capacity (LTO: 175 milliamperes per gram, mAh/g) of LTO.

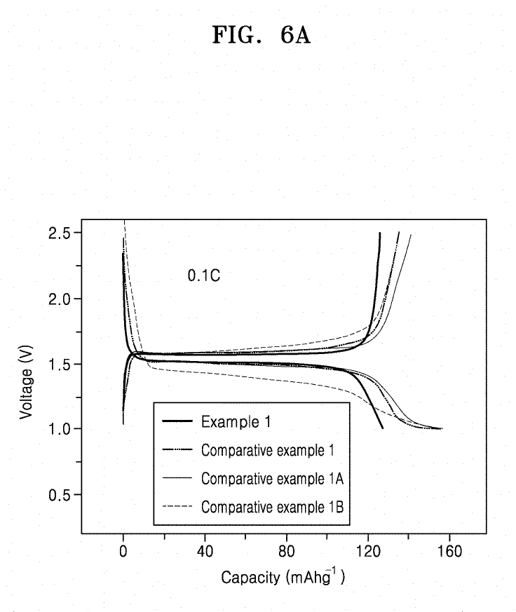

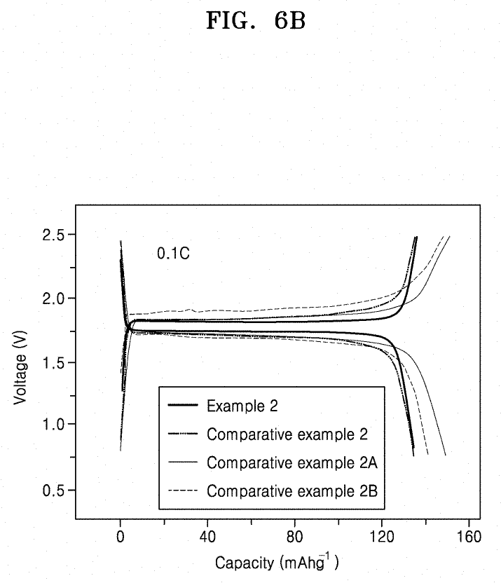

Charge and discharge characteristics evaluation results of each coin half-cell are shown in FIG. 6A.

Referring to FIG. 6A, it is confirmed that, although the coin half-cell of Comparative Example 1 was expected to have a decreased specific capacity even in a high loading amount, the stretchable LTO electrode of Examples 1, 1A and 1B exhibited a higher capacity than a metal foil-based electrode.

In the stretchable LTO electrode of Example 1B, the active material was partially detached from the PDMS sponge due to a high loading amount of LTO, and thus, this LTO electrode exhibited poorer electrochemical performance than the stretchable LTO electrodes of Examples 1 and 1A. The stretchable LTO electrode of Example 1B, however, had a specific capacity of 135 milliamperes per gram (mAhg⁻¹) at 0.1 C, which still shows good results.

### 2) Examples 2, 2A and 2B and Comparative Example 2

Charge and discharge characteristics of the coin half-cells manufactured according to Examples 2, 2A and 2B and Comparative Example 2 were evaluated.

The charge and discharge characteristics of each coin half-cell were evaluated under the following conditions.

Each coin half-cell was charged at a CC of 0.1 C up to 4.0 V, and then, discharged at a CC of 0.1 C until the voltage reached 2.5 V, and this cycle of charging and discharging was repeated 40 times.

A galvanostatic charge/discharge test of each coin half-cell was conducted using a 96-channel battery tester (Arbin Instruments) and the C-rate used was calculated based on a theoretical capacity (LFP: 170 mAh/g) of LFP.

The evaluation results are shown in FIG. 6B.

Referring to FIG. 6B, it is confirmed that the stretchable LFP electrodes of Examples 2, 2A and 2B exhibited higher capacities than the metal foil-based electrode of Comparative Example 2.

### Evaluation Example 3

### Rate Capabilities

### 1) Examples 1A and 1B and Comparative Example 1

Rate capabilities of the coin half-cells of Examples 1A and 1B and Comparative Example 1 were evaluated.

The rate capabilities of the coin half-cells were evaluated under the following conditions.

Each coin half-cell was charged at a CC of 0.1 C until the voltage reached 1.0 V, and then, discharged at a CC of 0.1 C until the voltage reached 2.5 V.

From the 2^{nd} cycle of charging, each coin half-cell was discharged at 0.2 C/0.5 C/1 C/2 C in the same charging/discharging voltage section.

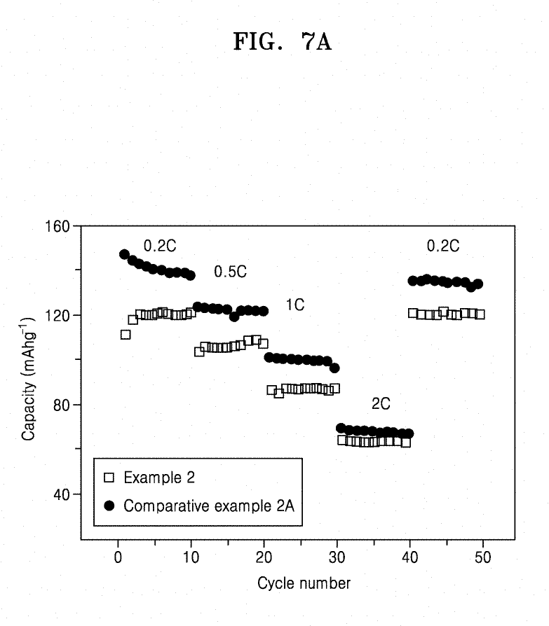

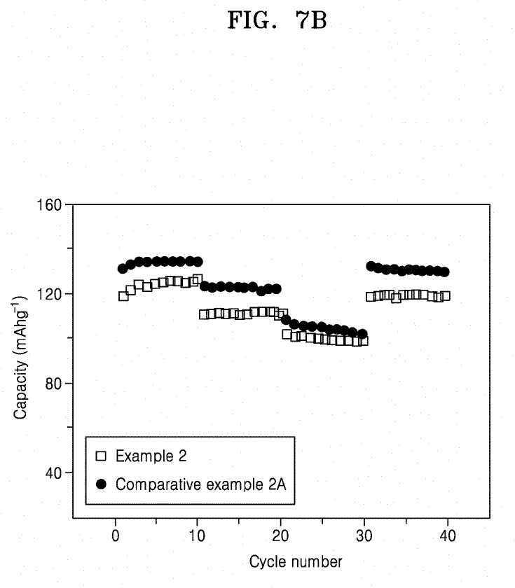

Rate capabilities evaluation results are shown in FIG. 7A.

Referring to FIG. 7A, it is confirmed that the stretchable LTO electrode of Example 1A had high conductivity in the charging and discharging cycles and thus exhibited high rate capabilities in various C-rate ranges (0.2 C to 1.0 C, mass loading: about 6.0 mg/cm⁻²) compared to the metal foil-based electrode of Comparative Example 1).

### 2) Example 2A and Comparative Example 2

Rate capabilities of the coin half-cells manufactured according to Example 2A and Comparative Example 2 were evaluated.

The rate capability of each coin half-cell was evaluated under the following conditions.

Each coin half-cell was charged at a CC of 0.1 C until the voltage reached 4.0 V, and then, discharged at a CC of 0.1 C until the voltage reached 2.5 V.

From the 2^{nd} cycle of charging, each coin half-cell was discharged at 0.2 C/0.5 C/1 C/2 C in the same charging/discharging voltage section.

Rate capability evaluation results of each coin half-cell are shown in FIG. 7B.

Referring to FIG. 7B, it is confirmed that the stretchable LFP electrode of Example 2A exhibited higher rate capability than the metal foil-based electrode of Comparative Example 2.

### Evaluation Example 4

### Elongation Measurement, Stress-Strain Curves and Images before and after Stretching

Elongations of the LTO electrode of Example 1 and the LFP electrode of Example 2 were measured. The elongation of each electrode was evaluated by measuring a strain-stress curve by dynamic mechanical analysis (DMS, TA Instrument Q800).

As confirmed by evaluation, the LTO electrode of Example 1 had an elongation of about 82%.

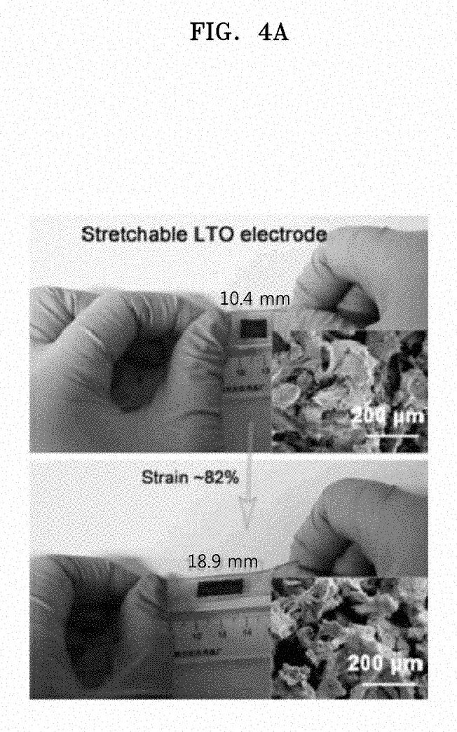

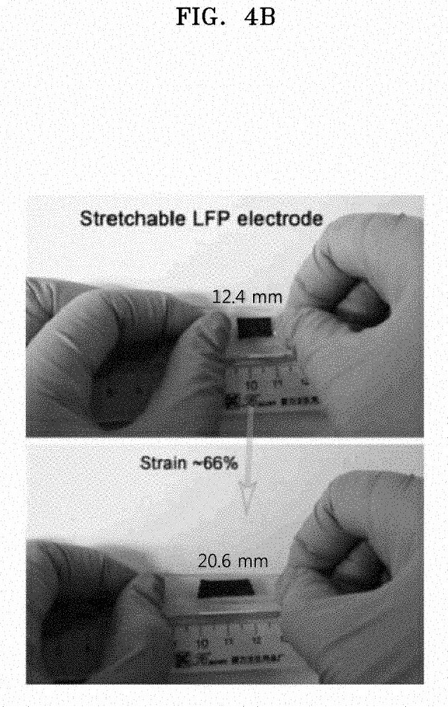

In addition, the states of the LTO electrode of Example 1 and the LFP electrode of Example 2 before and after stretching by hand were analyzed by digital photographs thereof, and the analysis results are shown in FIGS. 4A and 4B.

Referring to FIGS. 4A and 4B, the LTO electrode of Example 1 had a reversible elongation of 80%, and the LFP electrode of Example 2 had a reversible elongation of 66%.

The term “reversible elongation” as used herein refers to returning to the original length and state even after stretching.

In addition, stress-strain curves of the LTO electrode of Example 1 and the LFP electrode of Example 2 were obtained using a dynamic mechanical analyzer (DMA, TA Instrument Q800).

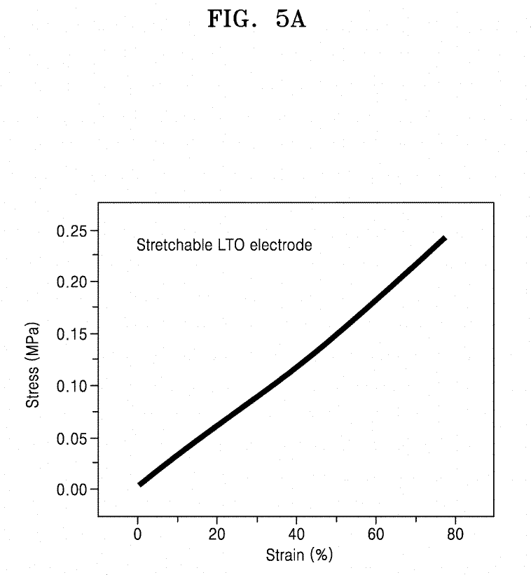

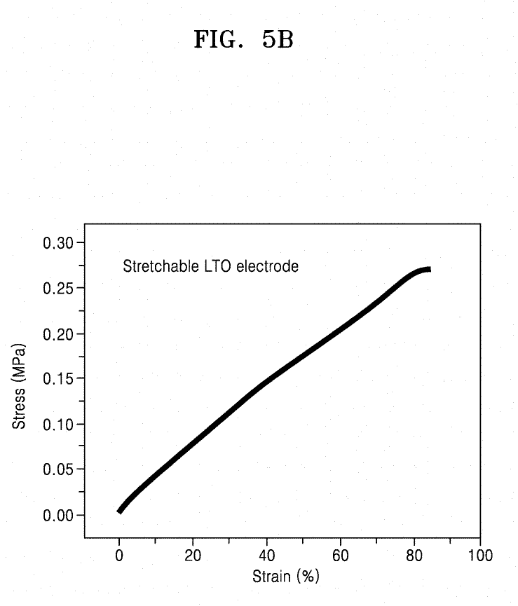

The stress-strain curves of the LTO and LFP electrodes are shown in FIGS. 5A and 5B, respectively.

Referring to the drawings, it is confirmed that the LTO electrode of Example 1 and the LFP electrode of Example 2 had reversible elongations.

### Evaluation Example 5

### Charge and Discharge Characteristics before and after Stretching (Stretching Reliability)

### 1) Examples 1 and 2

The LTO electrode of Example 1 and the LFP electrode of Example 2 were stretched at an elongation of 50% 100 times and 500 times, and then, 0.2 C charge and discharge characteristics of these electrodes were evaluated. Then, stretching reliability of each electrode was evaluated by observing changes in the charge and discharge characteristics. In this regard, the elongation of each electrode was evaluated by measuring a strain-stress curve by dynamic mechanical analysis (DMS, TA Instrument Q800).

To evaluate the 0.2 C charge and discharge characteristics, each coin half-cell was charged at a CC of 0.2 C until the voltage reached 1.0 V, and then, discharged at a CC of 0.2 C until the voltage reached 2.5 V.

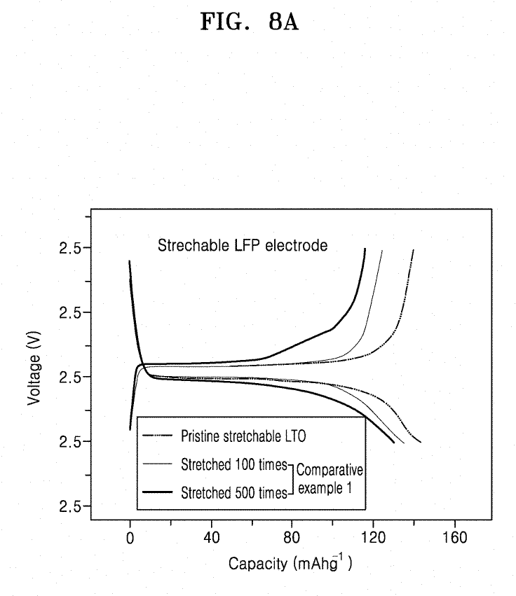

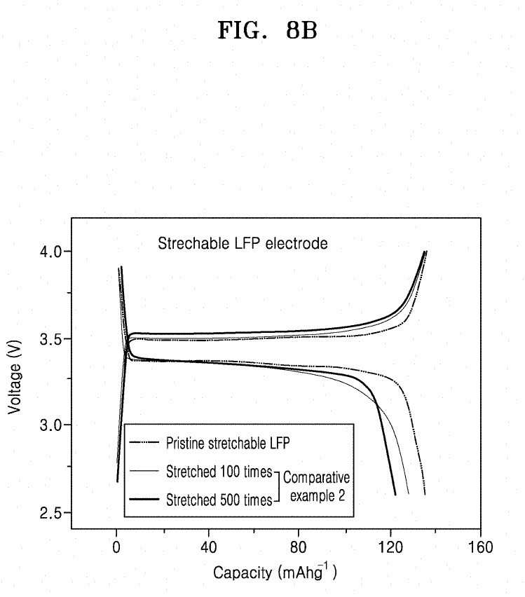

The stretching reliability evaluation results are shown in FIGS. 8A and 8B.

Referring to the drawings, the LTO electrode of Example 1 had a capacity retention of about 82% after stretching 500 times. The LFP electrode of Example 2 had a capacity retention of about 91% after stretching 500 times.

### 2) Example 3

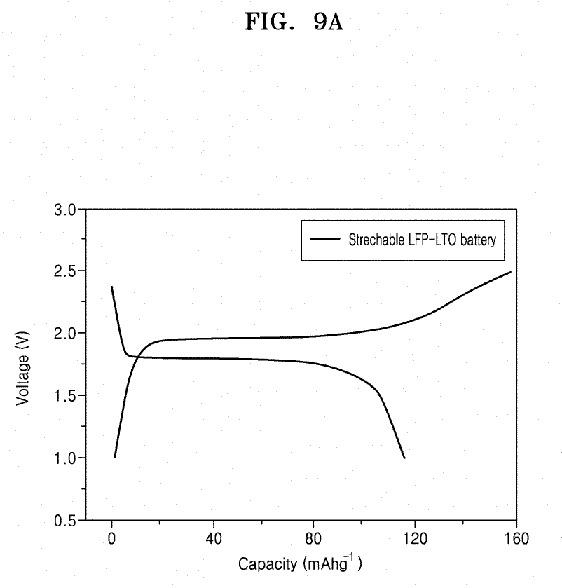

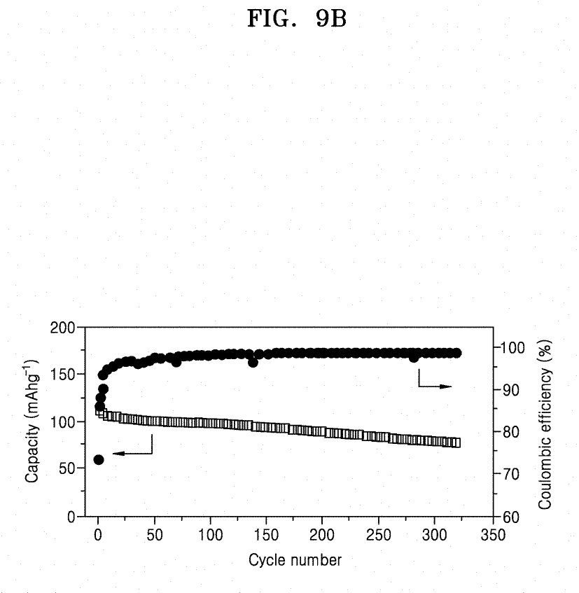

0.2 C charge/discharge characteristics and 1.0 C charge/discharge characteristics of the full cell of Example 3 were evaluated, and the evaluation results are shown in FIGS. 9A and 9B.

To evaluate the 0.2 C charge and discharge characteristics, the coin half-cell was charged at a CC of 0.2 C until the voltage reached 1.0 V, and then, discharged at a CC of 0.2 C until the voltage reached 2.5 V. To evaluate the 1.0 C charge and discharge characteristics, the coin half-cell was charged at a CC of 1.0 C until the voltage reached 1.0 V, and then, discharged at a CC of 1.0 C until the voltage reached 2.5 V.

Referring to FIG. 9B, the full cell of Example 3 had a lifespan of about 70% in the 1.0 C charging and discharging cycles even after 300 cycles. In addition, as illustrated in FIG. 9A, the 0.2 C charge/discharge characteristics of the full cell of Example 3 are the same as those of a battery including an existing electrode.

### Evaluation Example 6

### Capacity and Lifespan Characteristics

Capacity and lifespan characteristics of the full cell manufactured according to Example 4 were evaluated.

The 1^{st} and 2^{nd} charging and discharging cycles were performed at 25° C.

The full cell of Example 4 was charged at a CC of 0.1 C and a constant voltage (CV) of 4.5 V, and then, discharged at a CC of 0.1 C until the voltage reached 2.8 V.

From the 2^{nd} cycle of charging, the full cell was charged at a CC of 0.5 C and a CV of 4.5 V, and then, discharged at 0.2 C until the voltage reached 2.8 V. For cycle evaluation, the full cell was charged at a CC of 1 C and 4.5 V, and then, discharged at 1 C until the voltage reached 2.5 V.

The cycle of charging and discharging described above was repeated 20 times.

The capacity and lifespan characteristics of the full cell of Example 4 were evaluated and the evaluation results are shown in Table 1 below.

TABLE 1

| | Capacity of stretchable | Lifespan of stretchable |
|---|---|---|
| | full cell | full cell |
| | (mAh/g-LFP @ 0.2 C) | (% @ 0.2 C, 20^{th} cycle) |
| Pristine porous PDMS | 60 | <5 |
| separator | | |
| Al₂O₃-filled PDMS | 112 | >80 |
| separator | | |

Referring to Table 1, it is confirmed that a full cell manufactured using the Al₂O₃-filled PDMS separator exhibited a higher capacity and a longer lifespan than those of the full cell manufactured using the Pristine porous PDMS separator.

### Evaluation Example 7

By changing the thickness of the porous PDMS sponge separator of the full cell of Example 4 to 50 μm, 100 μm, and 300 μm, it was evaluated which thickness prevented the occurrence of a short circuit.

The thickness evaluation results are shown in Table 2 below.

TABLE 2

| | Minimum thickness (μm) of separator |
|---|---|
| | which prevents occurrence of short circuit |
| Pristine porous PDMS | 300 |
| separator | |
| Al₂O₃-filled PDMS | 100 |
| separator | |

Referring to Table 2, it is confirmed that the Al₂O₃-filled PDMS separator had an excellent short circuit prevention effect even with a small thickness.

### Evaluation Example 8

Porosity of the ball-milled sugar powder of Preparation Example 1 was measured. For the purpose of comparison with the porosity of the ball-milled sugar powder, the porosity of a commercially available sugar lump (Domino Granulated Pure Cane Sugar (15×15×15 mm) (Domino Foods, Inc., West Palm Beach, Fla., USA) was evaluated, and the evaluation results are shown in Table 3 below. The Porosity was measured using The SEM analysis results.

| | Porosity (%) |
|---|---|
| Ball-milled sugar powder of | 67.9 |
| Preparation Example 1 | |
| Sugar lump | 62 |

Referring to Table 3, the ball-milled sugar powder of Preparation Example 1 had a higher porosity, i.e., 67.9%, than that of the sugar lump.

As is apparent from the foregoing description, a porous electrode according to an embodiment is stretchable. By using such a stretchable porous electrode, a lithium battery with enhanced charge/discharge and lifespan characteristics, before and after stretching, may be manufactured.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A porous electrode for a lithium battery, comprising:
a porous structure having a plurality of pores and comprising polyorganosiloxane; and
an electrode active material layer disposed in the pores and on at least a portion of a surface of the porous structure.

2. The porous electrode of claim 1, wherein the porous electrode has an average pore size of about 0.1 micrometers to about 50 micrometers.

3. The porous electrode of claim 1, wherein the polyorganosiloxane has an elastic modulus of about 10 megapascals or less.

4. The porous electrode of claim 1, wherein the porous structure has a porosity of about 65% to about 80%.

5. The porous electrode of claim 1, wherein the polyorganosiloxane comprises at least one selected from:
at least one polymer selected from polydimethylsiloxane, vinyl-terminated polydimethylsiloxane, hydroxyl-terminated polydimethylsiloxane, and polyhydrosiloxane;
a copolymers having repeating units of the at least one polymer; and
a polymerization product thereof.

6. The porous electrode of claim 1, wherein the porous electrode has an elongation of about 1% to about 90%.

7. A method of manufacturing the porous electrode according to claim 1, the method comprising:
a first process comprising:
providing a mixture of a polyorganosiloxane prepolymer and a curing agent to a porous soluble material, and
heat-treating the resulting mixture;
a second process comprising:
preparing a porous structure having a plurality of pores and comprising polyorganosiloxane by mixing the heat treatment product obtained according to the first process with water to remove the porous soluble material from the heat treatment product; and
a third process comprising:
adding an electrode active material layer-forming composition comprising an electrode active material, a conductive agent, a binder, and a solvent to the porous structure, and
drying the resulting composition.

8. The method of claim 7, further comprising:
performing plasma treatment, UV irradiation, or ozone treatment on the porous structure obtained according to the second process.

9. The method of claim 7, wherein, in the first process, the porous soluble material is milled to have an average pore size of about 1 micrometers to about 50 micrometers.

10. The method of claim 7, wherein the porous soluble material comprises a sugar lump, a sugar powder, a sugar cube, or a ball-milled sugar powder.

11. The method of claim 7, wherein an amount of the curing agent is from about 2 parts by weight to about 20 parts by weight based on 100 parts by weight of the polyorganosiloxane prepolymer.

12. The method of claim 7, wherein the drying is performed at a temperature ranging from about 30° C. to about 100° C.

13. The method of claim 7, wherein the heat-treating is performed at a temperature ranging from about 50° C. to about 90° C.

14. The method of claim 7, wherein the polyorganosiloxane prepolymer comprises at least one selected from polydimethylsiloxane, vinyl-terminated polydimethylsiloxane, hydroxyl-terminated polydimethylsiloxane, and polyhydrosiloxane.

15. The method of claim 7, wherein the curing agent is a compound represented by Formula 2 below or a compound having a silicon-hydride bond: 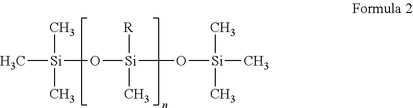
wherein, in Formula 2,
n is an integer of 1 to 100, and
R is hydrogen, a C₁-C₁₀ alkyl group, a C₃-C₁₀ cycloalkyl group, a C₁-C₁₀ fluoroalkyl group, or a C₃-C₁₀ fluorocycloalkyl group.

16. A lithium battery comprising the porous electrode according to claim 1 and a separator.

17. The lithium battery of claim 16, wherein the separator has a plurality of pores and comprises polyorganosiloxane.

18. The lithium battery of claim 17, wherein the porous structure has an average pore size of about 1 micrometers to about 30 micrometers and a thickness of about 10 micrometers to about 100 micrometers.

19. The lithium battery of claim 16, wherein, when strain on the porous electrode is from about 1% to about 20%, the porous electrode has a resistance change of about 100% or less.

20. The lithium battery of claim 16, wherein, when strain on the porous electrode is from about 1% to about 50%, the lithium battery has a capacity retention of about 70% to about 100% after 500 cycles.

21. The lithium battery of claim 17, wherein the porous electrode comprises an active material represented by Formula 4 below:
LiMₓFe₁₋ₓPO₄ Formula 4
wherein, in Formula 4,
M is at least one metal selected from cobalt (Co), nickel (Ni), and manganese (Mn), and
0≤x≤1.

22. The lithium battery of claim 16, wherein the porous electrode comprises an active material represented by Formula 3 below:
Li₄₊ₐTi_{5-b}M_{c}O_{12-d} Formula 3
wherein, in Formula 3,
−0.2≤a≤0.2,
−0.3≤b≤0.3,
0≤c≤0.3,
−0.3≤d≤0.3, and
M is at least one metal selected from Groups 1 to 6 and 8 to 15 of the Periodic Table.

23. The lithium battery of claim 16,
wherein the separator is a porous structure having a plurality of pores and comprising polyorganosiloxane, and
wherein the pores of the porous structure have inorganic particles disposed therein.

24. The lithium battery of claim 23, wherein the inorganic particles have a diameter of about 0.1 micrometers to about 50 micrometers and comprise at least one selected from silica (SiO₂), alumina (Al₂O₃), zirconium oxide (ZrO₂), titanium oxide (TiO₂), and a combination thereof.

25. The lithium battery of claim 23, wherein the lithium battery has a capacity retention of about 80% to about 99% after stretching 500 times.
